(19) United States
(12) Patent Application Publication
(10) Pub. No.: US 2006/0277803 A1
(43) Pub. Date: Dec. 14, 2006

(54) Sticker holder and protector for off-road vehicles

(76) Inventors: Russell R. Cotta, Madera, CA (US); Dana D. Cotta, Madera, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/150,669

(22) Filed: Jun. 10, 2005

(51) Int. Cl. G09F 7/00

(52) U.S. Cl. 40/209

(57) ABSTRACT

A sticker holder and protector apparatus for attaching a sticker type of identifying device to a mounting component, such as a fender, of an off-road vehicle, including motorcycles and all terrain vehicles. The preferred sticker holder has a sticker body with a sticker cavity, shaped to correspond to the identifying device, on the front side thereof for receiving the identifying device on the mounting surface thereof. One or more sidewalls, which substantially encircle the mounting surface, are chamfered to reduce the likelihood that rocks, bushes, power spray wash systems or other hazards will damage or remove the identifying device from the off-road vehicle. One or more screws or other mounting members can attach the sticker holder to the off-road vehicle. The sticker holder allows the owner or operator to replace the mounting component without having to acquire a replacement identifying device.

### CROSS-REFERENCE TO RELATED APPLICATIONS

None.

### BACKGROUND OF THE INVENTION

A. Field of the Invention

The field of the present invention relates generally to mounting apparatuses used to attach stickers, plates, cards or other identifying devices to vehicles. More particularly, the present invention relates to such mounting apparatuses that are configured to attach an identifying device to a motorcycle, three or four wheel all-terrain vehicle or other vehicles primarily configured for off-road or off-highway use. Even more particularly the present invention relates to such mounting apparatuses that permit the user to removably attach the identifying device to off-road vehicles in a manner that protects the device during use, cleaning and other activities.

B. Background

The popularity of off-road vehicles for entertainment, convenience and work activities is well known. Although the exact numbers of these vehicles are unknown and perhaps somewhat difficult to quantify, there are believed to be many millions of off-road vehicles that are in use today. For purposes of this disclosure, off-road vehicles include off-road motorcycles which are commonly referred to as dirt bikes, three and four wheel all-terrain vehicles (ATVs), go-carts, sand rails and like vehicles that are configured primarily or exclusively for use off the main roads and highways. Although off-road vehicles are not licensed or permitted for use on the roads and highways, their ownership and use is nevertheless somewhat regulated by state department of motor vehicles and/or other governmental entities. As part of this regulation, and in some part as a means to collect tax revenues, the governmental entities require the owners and users of the off-road vehicles to register the vehicle with the entity, pay required fees and obtain an identifying device that then becomes associated with the vehicle in much the same way that a license plate becomes associated with the cars, trucks, street motorcycles and other “on-road” vehicles. One purpose of these identifying devices is to identify the owner of the vehicle for purposes of regulating the vehicle's use (i.e., tickets for improper usage).

With regard to off-road vehicles, the prevalent form of identifying device utilized by regulating governmental entities is a sticker or other adhesive type of member that typically comprises a license number, month and year of license renewal and the regulating entity. In California, for instance, the Department of Motor Vehicles or DMV issues identifying devices that consist of a license sticker having the license number associated with a particular vehicle, the month and year the registration must be renewed and a statement (i.e., California Off Highway) designating the type of use allowed for that vehicle. Other states or their regulating entities generally utilize similar sticker types of identifying devices that include similar type of information. The stickers used for off-road vehicles are in contrast to the generally metal license plates utilized for on-road and other types of vehicles. As is well known, most on-road vehicles have a mounting location for the license plate that typically includes a license plate frame or like mounting apparatus suitable for the particular vehicle.

Off-road vehicles, particularly the dirt bikes and three/four wheel ATVs typically have a rear fender that is disposed somewhat over the rear tire or tires to prevent dirt, mud, rocks or other materials from being flung by the vehicle onto the rider and persons standing near or on vehicles following the subject vehicle. Commonly, the fenders of these vehicles are made out of plastic or other generally lightweight, strong material. The sticker or sticker-type of identifying devices that are issued by most state regulating entities are usually, often due to the regulations set forth by the entity, placed on the rear or one of the rear fenders of the off-road vehicle. If the vehicle does not have a fender, the identifying device is typically placed on another like covering portion of the vehicle, as opposed to an operating portion of the vehicle. The standard sticker identifying device is configured with a peel-off backing paper which is removed from the sticker so the sticker is affixed directly to the off-road vehicle's fender. Due to the nature of the typical use of off-road vehicles, the sticker is made with materials that are sufficient to securely adhere the sticker to the vehicle so that it will not fall off during use or be easily scraped off by contact with dirt, grass, bushes or other typical off-road riding hazards. In fact, the governmental entities issuing the identifying devices intend that the devices (i.e., stickers) are not easily removed from the vehicle or transferable from one vehicle to another.

Despite the intent of the governmental entities, as well as generally the owners and riders, certain problems with the sticker identifying devices are well known by those who own or operate off-road vehicles. One common problem is that the sticker remains adhered to the fender or other component (as it is generally intended) even when the fender or other component is destroyed or otherwise replaced. Unfortunately, it is not uncommon for off-road vehicles to crash or otherwise have undesirable contact with the ground, rocks, trees or other hazards. This is due somewhat to the nature of the use of most off-road vehicles and, to some extent, because many riders are generally inexperienced with such vehicles. These crashes, even if relatively minor, can result in damage to the off-road vehicle that necessitates replacement of the fender or other component on which the sticker identifying device is affixed. Even absent such crashes, the fender or other component may be replaced due to an equipment change or upgrade, which may be for aesthetic purposes. In any case, because any attempted removal of the sticker would void the license, even if successful (which is not generally possible), replacement of the component requires the sticker to be replaced. Typically, this requires the owner or operator of the vehicle to go to the appropriate governmental entity, wait in line and pay for a new identifying sticker for the vehicle.

Even when the fender or other component is not replaced as described above, the sticker-type of identifying device can be damaged in other ways. For instance, most off-road vehicles get caked in mud or otherwise get quite dirty during use. As a result, many owners/operators will use pressure washing equipment to wash the vehicle. Unfortunately, the force of the typical pressure washing system can damage the sticker and require replacement thereof. The use of the off-road vehicle in many desirably off-road environments can easily result in the identifying sticker being cut, torn, scraped or otherwise damaged due to contact with dirt, grass, bushes or other typical off-road riding hazards. This damage can void the sticker and void its use as an identifying device, thereby necessitating a trip to the regulating entity to obtain a new sticker for placement on the vehicle.

A number of mounting mechanisms are known and commonly available for mounting a typical, metal license plate to a motorcycle or other vehicle. For instance U.S. Pat. No. 4,790,087 to Hamada describes a license plate assembly for motorcycles that includes a stay configured to hold the license plate in a generally upright disposed position above a lamp unit that illuminates the license plate. U.S. Pat. No. 4,956,451 to Iwakura describes a mounting mechanism that has one or more rear-disposed reflectors and a license lamp to illuminate the license plate. U.S. Pat. No. 6,243,977 to Shuen is a knockdown or disassemblable license plate frame for changing the appearance of the vehicle's license plate. U.S. Pat. No. 6,478,458 to Hickman describes an illuminated motorcycle license plate housing that provides a removable message bar that is illuminated by a light disposed behind the housing. U.S. Pat. No. 6,592,137 to Grove discloses a license plate mounting that is configured to be mounted on the foot peg of a motorcycle and be pivoted from an outwardly extending position to a folded position. Although the foregoing describe holder apparatuses configured for use with motorcycle, none of the above disclose an apparatus particularly configured to hold and protect the sticker-type of identifying device commonly utilized for off-road vehicles. In addition, none of the foregoing appear to be suitable for the rigorous use to which off-road vehicles are generally subjected.

Besides the fees associated with obtaining a new sticker, the time element of this process (i.e., going to the governmental entity office, waiting in line, etc.) can be somewhat frustrating to the typical off-road vehicle owner or operator. To date no known mounting apparatus which is suitable for use with the typical sticker type of identifying device and off-road vehicles is available. What is needed, therefore, is an apparatus suitable for holding such identifying devices on an off-road vehicle. The preferred apparatus is one that will not be easily damaged during use of the off-road vehicle and which facilitates removal of the identifying device from the vehicle when the mounting surface, such as the fender, is replaced due to damage or upgrade. The preferred apparatus will be configured to fixedly receive the typical sticker-type of identifying device thereon and protect the device from damage during use of the vehicle. The preferred apparatus will also be configured such that cleaning of the vehicle with high pressure washers will be much less likely to result in damage to the identifying device. The preferred apparatus will be suitable for use with new and existing off-road vehicles.

### SUMMARY OF THE INVENTION

The sticker holder and protector for off-road vehicles of the present invention solves the problems and provides the benefits identified above. That is to say, the present invention discloses a new and improved holding apparatus for off-road vehicle identifying devices that is adaptable to wide variety of different sizes and configurations of identifying devices, particularly the sticker type of device commonly used by many regulating entities. The sticker holder and protector apparatus of the present invention provides a removably mountable location for receiving a sticker type of identifying device on an off-road vehicle while protecting the identifying device from damage during use, cleaning or other activities associated with the off-road vehicle. The sticker holder and protector apparatus of the present invention is adaptable for a variety of different types of off-road vehicles, can be manufactured out of a variety of different materials and in different configurations and is suitable for use with both new and existing off-road vehicles. With use of the sticker holder and protector of the present invention, the owner or operator of an off-road vehicle can replace (typically due to damage or upgrade) the sticker mounting component, usually a fender, without having to replace the identifying device, thereby saving money, time and frustration with regard to such identifying devices.

In one general aspect of the present invention, the sticker holder and protector for off-road vehicles includes a holder body having a front side and a back side with a sticker cavity located in the front side of the holder body that is sized to have substantially the same dimensions as the sticker identifying device. The sticker cavity has a mounting surface for receiving the identifying device and one or more shaped side walls that are circumferentially disposed about the mounting surface. Preferably, the mounting surface is substantially planar and includes one or more removal apertures to assist the owner/operator of the off-road vehicle with removing expired identifying devices (i.e., stickers) from the holder body. Also in the preferred embodiment, the side walls are shaped at an angle of 35 to 55 degrees, with 45 degrees being the most preferred, to reduce the likelihood the sticker will be torn, ripped or blown off of the sticker body during use or washing of the off-road vehicle. The mounting body has a mechanism for mounting the holder to the mounting component, such as the fender, of the off-road vehicle so as to display the identifying device outwardly of the off-road vehicle, as typically required by the relevant governmental entity. In a preferred embodiment, the mounting mechanism includes one or more mounting apertures disposed through the holder body, each of which is configured to receive a mounting member, such as a screw, bolt or other connector, configured to attach to the off-road vehicle. Preferably, the connector removably attaches the holder body in an abutting relation with the off-road vehicle's mounting component. In an alternative embodiment, the back side of the holder body includes an adhesive that is suitable for attachment to the mounting component.

Accordingly, the primary objective of the present invention is to provide a sticker holder and protector for off-road vehicles that provides the advantages discussed above and that overcomes the disadvantages and limitations associated with present mechanisms for attaching a sticker type of identifying device to an off-road vehicle.

It is also an object of the present invention to provide a sticker holder and protector apparatus that is configured to removably mount a sticker type of identifying device to an off-road vehicle, such as a dirt bike, ATV and like vehicles so as to allow replacement of the sticker mounting component without having to remove or otherwise obtain a new identifying device.

It is also an object of the present invention to provide a sticker holder and protector apparatus that provides a mounting surface for receiving a sticker type of vehicle identifying device and a mechanism for removably mounting the apparatus to an off-road vehicle.

It is also an object of the present invention to provide a sticker holder and protector apparatus that comprises a holder body member having a sticker shaped cavity having a mounting surface and one or more circumferentially enclosing beveled side walls to hold the sticker thereon and to protect the sticker during use, cleaning and other off-road vehicle activities.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a rear view of a dirt bike type of off-road vehicle showing placement of a sticker holder and protector configured according to a preferred embodiment of the present invention attached to the motorcycle's rear fender;

FIG. 2 is a rear view of an ATV type of off-road vehicle showing placement of a sticker holder and protector configured according to a preferred embodiment of the present invention attached to one of the ATV's rear fenders;

FIG. 3 is a top perspective view of a sticker holder and protector configured according to a preferred embodiment of the present invention showing a sticker type of identifying device affixed thereto;

FIG. 4 is an exploded view of the sticker holder and protector of FIG. 3 shown with a set of mounting screws configured to removably mount the apparatus to an off-road vehicle; and

FIG. 5 is a bottom perspective view of the back side of a sticker holder of an alternative embodiment of the present invention configured with an adhesive material thereon.

### DETAILED DESCRIPTION OF THE PREFERRED EMBODIMENTS

With reference to the figures where like elements have been given like numerical designations to facilitate the reader's understanding of the present invention, and particularly with reference to the embodiments of the sticker holder and protector for off-road vehicles of the present invention illustrated in the figures, various preferred embodiments of the present invention are set forth below. The enclosed description and drawings are merely illustrative of preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

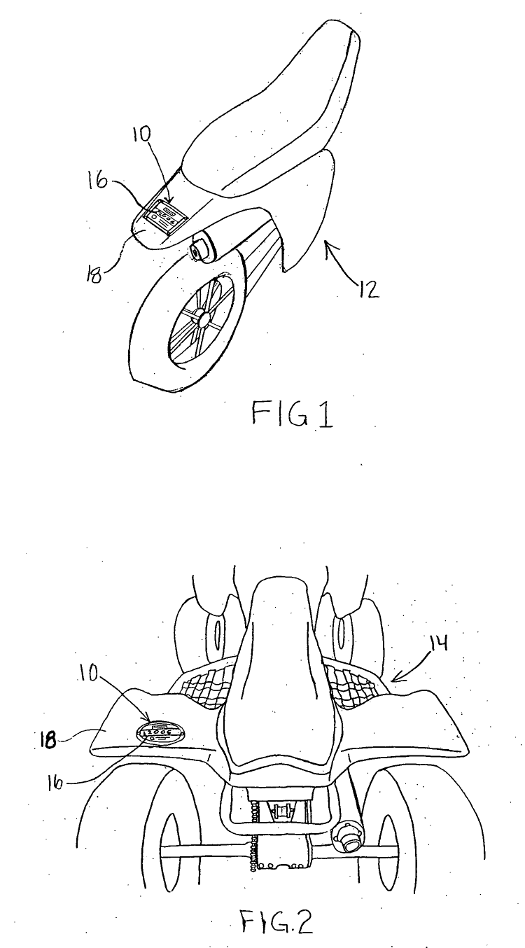

In the preferred embodiments of the sticker holder and protector apparatus of the present invention, shown in the figures, the sticker holder is identified generally as 10. FIGS. 1 and 2 included herewith show preferred embodiments of sticker holder 10 mounted on off-road vehicles, such as a dirt bike type of motorcycle 12 and ATV 14. As discussed generally above, sticker holder 10 is configured for removably mounting the sticker type of identifying device, shown as 16, on a fender 18 or other suitable mounting component of motorcycle 12 or ATV 14. Although fender 18 may be made out of a variety of different types of materials, including metal, plastics, composites and the like, they are generally made out of a strong rigid plastic material to reduce the weight and cost of fender 18. While such fenders 18 are generally tough, they are subject to damage if the owner or operator of the off-road vehicle 12 or 14 crashes or otherwise causes an impact against fender 18. In addition, for a variety of reasons, including aesthetic, the owner or operator of motorcycle 12 or ATV 14 may want to replace fender 18. Prior to the present invention, the identifying device 16 is usually affixed directly to fender 18. Often, this is pursuant to regulations enforced by the appropriate governmental regulating entity, such as a state department of motor vehicles. Because the typical sticker type of identifying device 16 is provided with a sticky material on the underside thereof (not shown) that is intended to essentially permanently attach to the fender 18 of vehicle 12 or 14, such that the identifying device 16 cannot be easily removed or reused therefrom, any replacement of fender 18 necessitates replacement of identifying device 16. As set forth above, this generally requires the owner or operator of vehicle 12 or 14 to make a trip to the appropriate government entity to purchase a new sticker 16. Typically, the owner/operator will have to wait in line to make his or her purchase. As such, the present configuration of affixing stickers directly to the fender 18 or other mounting component of off-road vehicle 12 or 14 can result in a frustrating waste of money and time.

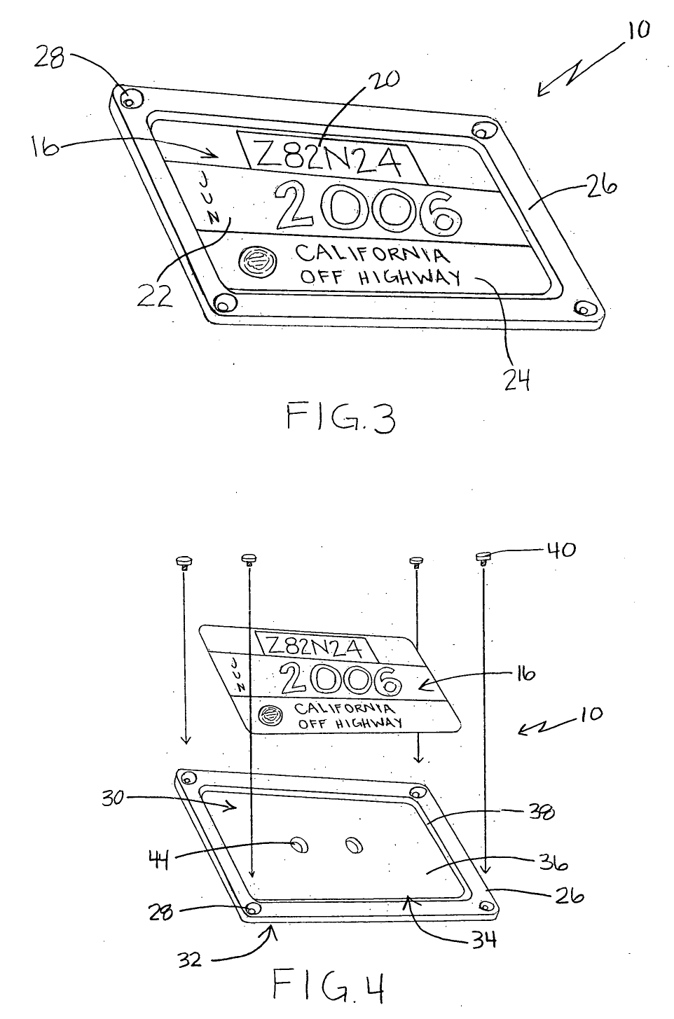

As best shown in FIG. 3, the typical sticker type of identifying device 16 is configured to essentially fixedly attach to the fender 18 or other mounting component of the typical off-road vehicle, such as motorcycle 12 or ATV 14. To accomplish this result, identifying device 16 is provided with an underside that comprises a sticky substance which is selected for its ability to securely attach to plastic, metal or other materials commonly used on off-road vehicles 12 or 14. As is well known, the sticky substance used for such identifying devices 16 is also suitable for attaching to a previously applied identifying device 16 such that a layer of such stickers 16 is usually affixed to the vehicle, generally because they are difficult to remove. In the configuration shown in FIG. 3, which is for a California registered off-road vehicle, identifying device 16 has a vehicle license number 20, an expiration or renewal date 22 and a regulating entity identification 24. Different states or other government entities are likely to have a different layout or configuration for identifying device 16 and/or have different information placed thereon. Generally, all such identifying devices 16 are configured to provide a relatively easy means for identifying the owner or other registrant of vehicle 12 or 14, the expiration or renewal date by which vehicle 12 or 14 must be registered and the regulating entity (i.e., state) where the vehicle 12 or 14 is registered. They are also generally configured to be very difficult to remove in a single, reusable piece in order to prevent reuse of the identifying device and to discourage falsely making it appear that an off-road vehicle, such as 12 or 14, is registered when in fact it is not.

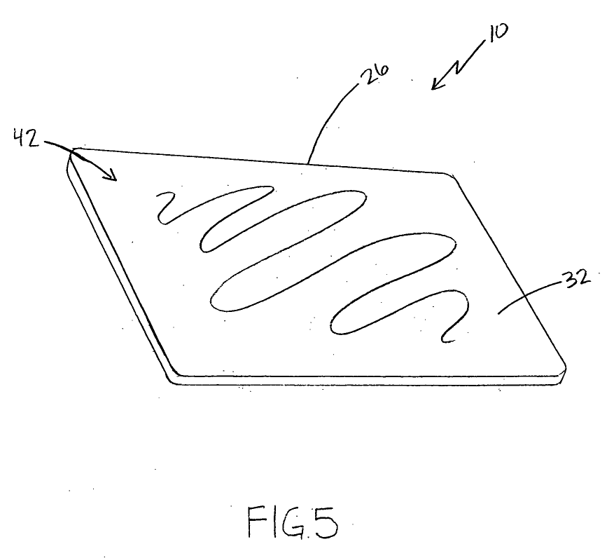

In the preferred configuration of the present invention, best shown in FIGS. 3 and 4, sticker holder 10 generally comprises a holder body 26 and a mechanism thereon, such as one or more mounting apertures 28, for attaching holder 10 to a mounting component, such as fender 18, of off-road vehicle 12 or 14. Holder body 26 has a front side 30 that is configured to face outwardly from off-road vehicle 12 or 14 and an opposite facing back side 32 that is configured to generally abut fender 18. The front side 30 of holder body 26 is provided with a sticker cavity 34 having a mounting surface 36 for receiving identifying device 16 thereon. In the preferred embodiment, mounting surface 36 is substantially circumferentially enclosed by one or more, depending on the shape of sticker cavity 34, shaped side walls 38. Also in the preferred embodiment, mounting surface 36 and back side 32 are substantially planar. As will be readily understood and recognized by those skilled in the art, sticker holder 10 of the present invention can be manufactured out of a variety of different materials and in a variety of different configurations. Preferably, holder body 26 is made from a material that is generally strong to withstand contact against rocks and other off-road hazards, reasonably adaptable into the desired configuration, lightweight so as to not add significantly to the weight of motorcycle 12 or ATV 14 and, because it will be exposed to the sun and other elements, both corrosion and ultraviolet light resistant. The inventor has found that aluminum, such as 6061 T-6 aluminum, is a preferred material for holder body 26. Other metals, as well as various plastics and composites, would also be suitable for holder body 26 of the present invention.

As shown in FIGS. 3 and 4, identifying device 16 is configured to be received in sticker cavity 34. Generally, this will result in the sticky underside of identifying device being stuck to mounting surface 36 such that the identifying information, such as license number 20, renewal date 22 and entity identification 24 are displayed in an outwardly facing direction from off-road vehicle 12 or 14, as shown in FIG. 3. Although holder body 26 can be configured in any desired shape, such as the rectangular shape of FIGS. 1 and 3 through 5 or the round shape of FIG. 2, sticker cavity is preferably shaped and configured to correspond to the shape of identifying device 16 such that identifying device 16 substantially covers mounting surface 36 between shaped side walls 38. For instance, if identifying device 16 is rectangular, then it is preferred that sticker cavity 34 be configured in a rectangular shape have corresponding length and width dimensions. Likewise, if identifying device 16 is round, it is preferred that sticker cavity 34 be configured in a circular shape having corresponding diameter dimension. Providing sticker cavity 34 with a corresponding shape and dimension to identifying device 16 provides improved protection for the identifying device 16 during use or cleaning of off-road vehicle 12 or 14. In this manner, identifying device 16 is much less likely to be partially or completely pulled up by contact with a rock, bush or other hazard or by the force of the fluid from a high pressure spray system. To further reduce the likelihood that identifying device 16 will be inadvertently torn or pulled off of holder 10, the walls 38 are shaped with a bevel or bevel-like configuration, commonly referred to as chamfer. The angle of the shaped walls 38 should be selected so as to reduce the tendency of identifying device 16 to be torn or pulled from holder 10. The inventors have found that shaped walls 38 having an inwardly sloping angle of 45 degrees, with a likely range of 35 to 55 degrees, sufficiently prevents or reduces the likelihood that identifying device 16 will be pulled, torn or blown off holder 10.

In the preferred embodiment, best shown in FIGS. 3 and 4, sticker holder 10 of the present invention is provided with a mechanism to securely yet removably mount holder body 26 to off-road vehicle 12 or 14. In this preferred embodiment, each mounting aperture 28 is configured to receive a mounting member 40, such as a screw or bolt, therein that is configured to attach to the mounting component, such as fender 18, of off-road vehicle 12 or 14. In one configuration, mounting members 40 are screws that are configured to be screwed into fender 18. Although a variety of other mechanisms are also available for mounting holder body 26 onto off-road vehicle 12 or 14, such as rivets, welding or the like, the use of screws or bolts as mounting members 40 facilitates the removal of sticker holder 10 if the fender 18 or other mounting component becomes damaged or the owner/operator decides to upgrade or otherwise change out the mounting component. This avoids destruction of identifying device 16 and the necessity to replace it that is common with the present direct mounting of identifying device 16 to the mounting component of off-road vehicle 12 or 14. In an alternative embodiment, shown in FIG. 5, the back side 32 of holder body 26 can comprise an adhesive material, shown as 42, that is selected as being suitable for attaching holder body 26 to off-road vehicle 12 or 14. For instance, various glues or double sided tapes are generally suitable for use as adhesive material 42. This type of attachment mechanism, however, is not preferred due to the difficulty that may be encountered in removing holder body 26 from off-road vehicle 12 or 14, which would put the owner or operator of off-road vehicle 12 or 14 in virtually the same position as the current method of attachment (except that identifying device 16 would be better protected against damage).

In the preferred embodiment, as shown in FIG. 4, mounting surface also comprises one or more removal apertures 44 thereon to assist the owner or operator of off-road vehicle 12 or 14 with removing any expired or otherwise no longer valid identifying device 16 from sticker holder 10 of the present invention. As is common, most owner/operators of off-road vehicles 12 or 14 will attach a renewal identifying device 16 on top of an expired identifying device 16, creating layers of several of such identifying devices 16, in sticker cavity 34. At some point, it will likely become advantageous to remove identifying device(s) 16 from sticker holder 10. At that time the owner/operator will be able to place a pencil, pen or other elongated object through removal aperture 44 from the back side 32 of holder body 26 to force identifying device 16 upward so that it may be removed from sticker holder 10. Without removal aperture(s) 44, the owner/operator will have to peel off the one or more identifying devices 16 from the edges thereof, which is often not that easy to do. Use of tools or other devices to remove the identifying device 16 could damage the surface of sticker holder 10 or cause damage to off-road vehicle 12 or 14.

In one configuration, which is set forth for purposes of providing an exemplary sticker holder 10 and not for purposes of limiting the present invention to the foregoing, holder body 26 is rectangular and has an outside dimension of five inches by three and one-half inches with a sticker cavity 34 having a dimension of approximately four inches by three inches. Four countersunk mounting apertures 28 having approximately two tenths of an inch diameter openings are provided near the corners of holder body 26. Holder body 26 can be approximately one-quarter of an inch thick with a one-eighth of an inch chamfer for the shaped side walls 38 of sticker cavity 34. Removal apertures 44 can be approximately one-half an inch in diameter and spaced approximately two inches on center. In use, identifying devices 16 are attached to sticker holder 10 of the present invention by peeling of the protective coating from the sticky underside of identifying devices 16 and placing it against mounting surface 36. Sticker holder 10 is then removably attached to a mounting component, such as fender 18, of off-road vehicle 12 or 14 as may be required by the applicable state laws or regulating entity regulations. Alternatively, sticker holder 10 can be attached to off-road vehicle 12 or 14 first, with identifying device then placed on mounting surface 36 of sticker cavity 34. The off-road vehicle 12 or 14 can then be ridden, washed and otherwise used as normal with less risk of damage to identifying device 16. As such, use of sticker holder 10 will substantially reduce the likelihood of having to replace identifying device 16, thereby saving time and money for the owner/operator of off-road vehicle 12 or 14.

While there are shown and described herein certain specific alternative forms of the invention, it will be readily apparent to those skilled in the art that the invention is not so limited, but is susceptible to various modifications and rearrangements in design and materials without departing from the spirit and scope of the present invention. In particular, it should be noted that the present invention is subject to modification with regard to assembly, materials, size, shape and use. For instance, some of the components described above can be made integral with each other to reduce the number of separate components and various replacement components can be utilized that perform the same function as those described above.

What is claimed is:

1. A holder for attaching an identifying device to an off-road vehicle, said holder comprising:
a holder body having a front side and a back side;
a sticker cavity in said front side of said holder body, said sticker cavity having a mounting surface and one or more shaped side walls circumferentially disposed about said mounting surface; and
means on said holder body for mounting said holder to said off-road vehicle so as to display said identifying device outwardly of said off-road vehicle.

2. The holder according to claim 1, wherein said mounting means comprises one or more mounting apertures through said holder body, each of said mounting apertures configured to receive a mounting member configured to attach to said off-road vehicle.

3. The holder according to claim 1, wherein said mounting means comprises an adhesive material on said back side of said holder body.

4. The holder according to claim 1, wherein said mounting surface is substantially planar.

5. The holder according to claim 1, wherein said mounting surface has one or more removal apertures.

6. The holder according to claim 1, wherein said sticker cavity is shaped and configured substantially the same as said identifying device.

7. The holder according to claim 1, wherein said shaped side walls are chamfered at an angle of approximately 35 to 55 degrees.

8. The holder according to claim 7, wherein said side walls are chamfered at an angle of 45 degrees.

9. A holder for attaching an identifying device to an off-road vehicle, said holder comprising:
a holder body having a front side and a back side;
a sticker cavity in said front side of said holder body, said sticker cavity having a generally planar mounting surface and one or more shaped side walls circumferentially disposed about said mounting surface, said sticker cavity shaped and configured substantially the same as said identifying device, said side walls chamfered at an angle of approximately 35 to 55 degrees; and
means on said holder body for removably mounting said holder to said off-road vehicle so as to display said identifying device outwardly of said off-road vehicle.

10. The holder according to claim 9, wherein said mounting means comprises one or more mounting apertures through said holder body, each of said mounting apertures configured to receive a mounting member configured to attach to said off-road vehicle.

11. The holder according to claim 9, wherein said mounting surface has one or more removal apertures.

12. A holder for attaching an identifying device to an off-road vehicle, said holder comprising:
a holder body having a front side and a back side;
a sticker cavity in said front side of said holder body, said sticker cavity having a generally planar mounting surface and one or more shaped side walls circumferentially disposed about said mounting surface, said sticker cavity shaped and configured substantially the same as said identifying device, said side walls chamfered at an angle of approximately 35 to 55 degrees; and
one or more mounting apertures through said holder body, each of said mounting apertures configured to receive a mounting member configured to removably attach to said off-road vehicle so as to display said identifying device outwardly of said off-road vehicle.

13. The holder according to claim 12, wherein said mounting surface has one or more removal apertures.
